(19) United States
(12) Patent Application Publication
(10) Pub. No.: US 2025/0326185 A1
(43) Pub. Date: Oct. 23, 2025

(54) FASTENING METHOD

(71) Applicant: Gottlieb Binder GmbH & Co. KG, Holzgerlingen (DE)

(72) Inventors: Lars Heepe, Tuebingen (DE); Halvor Tramsen, Holzgerlingen (DE); Dirk-Michael Drotlef, Tiefenbronn (DE); Dennis Petersen, Sindelfingen (DE)

(73) Assignee: Gottlieb Binder GmbH & Co. KG, Holzgerlingen (DE)

(21) Appl. No.: 19/253,622

(22) Filed: Jun. 27, 2025

Related U.S. Application Data
(62) Division of application No. 18/349,080, filed on Jul. 7, 2023.

(30) Foreign Application Priority Data
Jul. 8, 2022 (DE) 10 2022 117 132.9

(51) Int. Cl. B29C 65/52; B29L 31/00; C09J 7/25; C09J 7/38

(52) U.S. Cl. CPC B29C 65/522; C09J 7/25; C09J 7/383; B29L 2031/727; C09J 2301/208; C09J 2301/502; C09J 2421/00; C09J 2475/00; C09J 2483/00

(57) ABSTRACT

A method for attaching a fastening system is disclosed. The fastening system has an application agent which, when viewed in relation to a surface to which it is applied, forms a smooth adhesion surface, in particular, after curing, and a functional part which, on its side facing the adhesion surface, has a functional surface which can be secured to the adhesion surface in a releasable manner. The method includes applying an agent onto the surface, allowing the application agent to cure so as to form a smooth adhesion surface, and attaching the functional part via microstructures of one functional surface to the adhesion surface of the cured application agent.

### CROSS-REFERENCE TO RELATED APPLICATIONS

This application is a divisional application of Ser. No. 18/349,080 filed on Jul. 7, 2023, which itself claims priority to German Patent Application No. 10 2022 117 132.9, filed Jul. 8, 2022, the entire contents of which are hereby incorporated in full by this reference.

### DESCRIPTION

### Field of the Invention

The invention relates to a fastening system and method thereof.

### Background of the Invention

Such fastening systems are used, among other things, to attach functional objects such as mirrors, lamps, wall hooks, etc., as well as art objects such as pictures and paintings to the walls of a building. Nails and screws have proven successful as conventional fastening means, the latter often firstly being fastened in the wall as part of the fastening system via a dowel introduced into a wall bore hole, and then being attached to the wall in a removable manner via the mounting of the functional or art object created in this way. If, for example, the nails or wall dowel fastening systems are then to be removed from the wall again in the course of a relocation, unattractive holes are frequently produced in the wall, the elimination of which entails a corresponding renovation effort.

In order to overcome these disadvantages, it has already been proposed in practice to use so-called double-sided adhesive strips which can be secured by one adhesive side to the wall and which, with their other free, opposing adhesive side, make it possible to secure the functional or art object to the wall. However, these are often permanent connections, the elimination of which is frequently accompanied by damage to the object placed on the wall and/or to the wall itself, which is often provided with a wallpaper, but at least with a wall paint, which can peel off from the wall in an unsightly manner. The load-bearing capacity of such adhesive tapes is also restricted and is less suitable for hanging heavy objects.

Furthermore, in the prior art (EP 1 101 428 A1), one-piece wall and ceiling hooks are known as a fastening system which is composed of a base plate which is designed for bonding with a strip of a double-sided adhesive film that can be unstuck by means of pulling such that a grip tab of the adhesive strip projects beyond the base plate, and is composed of a hook body which has a first bend and a counter-bend and which is placed on said base plate. By pulling the grip tab accordingly, the adhesive strength of the strip is reduced such that the connection of the hook to the wall or ceiling can be released without leaving residue. Although the hook is available for repeated bonding, the size of the hook also limits the size of the double-sided adhesive film used and thus the possibilities of use.

### SUMMARY OF THE INVENTION

Proceeding from this prior art, the object of the invention is to provide a fastening system which is improved in relation thereto and which can be removed without leaving residue and/or can be painted over again, without adversely affecting other objects and thereby also allows for the realization of large securing surfaces.

This object is achieved by a fastening system having the features of claim 1, consisting at least of: an application agent which, when viewed in relation to a surface to which it is applied, forms a smooth adhesion surface, in particular after curing; and a functional part which, on its side facing the adhesion surface, has a functional surface which can be secured to the adhesion surface in a releasable manner.

The basic idea of the fastening system according to the invention is therefore to level a rough surface, as is given, for example, by the walls of a building, in that an application agent, which is additionally applied to the wall from the outside, forms an adhesion surface that is smoother relative to the rough wall after curing due to its material-specific inherent surface tension. The resulting roughness of the smoother adhesion surface can be described according to Haytam Kasern and Michael Varenberg (Effect of counterface roughness on adhesion of mushroom-shaped microstructure; Journal of the Royal Society Interface; 2013) by an integrative roughness measure which should be less than or equal to 75 μm². In this way, the fastening means is particularly suitable for subsequent attachment to unplastered, potentially merely painted, masonry, rough concrete walls, tiles and roughcast, but also for wallpapers, such as woodchip wallpaper, having corresponding surface irregularities, it potentially being necessary to carry out (spray) application with the application agent multiple times in advance. After the smooth adhesion surface has been produced, a functional part is subsequently used as a further part of the fastening system, which functional part has a functional surface on its side facing the cured adhesion surface, which functional surface can be secured in a releasable manner on the adhesion surface, which preferably takes place by means of adhesion, in which an “adhesive” bonding of the functional surface to the adhesion surface on the surface of a building wall often takes place using so-called Van der Waals forces. On the side of the functional component facing away from the functional surface, a preferably free surface which can be provided with an adhesive can be used to attach further fastening components, such as a fastening hook.

The application agent may have a lower roughness at the adhesion surface than the surface.

The application agent is preferably applied in the form of a spray application. The application agent may be applied in the form of a spray plaster (spray-on plaster).

The application agent may be in the form of an adhesive strip. The adhesive strip may have a plastics film, which is coated thinly on one side with adhesive. The plastics film may, in particular, be made of polyethylene terephthalate (PET) and/or—preferably for disposal reasons-polypropylene (PP) and/or polyethylene (PE). Acrylic, hot-melt adhesive and/or rubber are preferably considered as an adhesive. The adhesive strip may be reinforced by an—in particular, anisotropic-textile fabric.

In a preferred embodiment of the fastening system according to the invention, the application agent is applied to the surface in liquid form. In other words, a rough surface is sprayed with a liquid, curing substance, such that the critical roughness wavelengths are eliminated. The liquid can also be applied to the rough surface by means of brushing, dabbing, squeegeeing, spreading and the like.

Preferably, the application agent can also be removed from the surface without leaving residue after curing. Alternatively, it is possible to cover the application agent with a coat of paint, which preferably corresponds to an adjacent color arrangement on the wall. In this way, in the event of an incorrect application at the wrong location, this application can be immediately reversed and an application process can be initiated again at a different location with little effort. Furthermore, a fastening that is no longer required can be removed without damage to third-party components.

It has proven to be particularly advantageous for the fastening system if the functional surface of the functional part is microstructured, the functional surface of the functional part preferably being composed of 15,000 to 55,000, more preferably of 25,000 to 35,000, so-called adhesive elements per cm² of the functional surface.

The film-like functional part consists of a silicone material which can be processed well during conventional microreplication methods, for example using a so-called chill roll method.

Due to the fact that the functional part is preferably in the form of a film, it can be stored in a space-saving manner, for example it can be rolled up in such a way that the functional part can be provided for use in that it is cut out in a precise manner by means of conventional household scissors on site. Alternatively, the functional part can consist of individual patches which have already been cut to a corresponding size beforehand.

In a particularly preferred embodiment of the fastening system according to the invention, the liquid, fast-curing application agent is based on the following, in each case individually or in combination: acrylate; silicone; polyurethane; rubber; lacquer; cellulose.

These application agents can also be applied, in particular, within the scope of a spray application process if the underlying rough surface has dirt particles, such as conventional household dust.

A sales set is particularly preferably used, at least consisting of at least one spraying device for applying a liquid, curing application agent and at least one film-like functional part having a functional surface having microstructures. The sales set can be supplemented by further functional components, for example in the form of a fastening hook to be glued onto the functional part. All components of the sales set are accommodated in a preferably transparent film pouch. For this purpose, the functional part is self-adhesive on its rear side facing away from the functional surface having the microstructures or has a back layer, for example in the form of a preferably fluorinated plastics film, which allows for an additional adhesive coating between the functional and fastening parts, such as a fastening hook.

In order to attach the fastening means described above, which can be removed from a sales set, for example using a film pouch, a method having at least the following method steps is used: applying, in particular spraying, a, preferably liquid, application agent onto a surface; preferably allowing the application agent, in particular the spray coating, to cure so as to form a smooth adhesion surface; and attaching a film-like functional part via microstructures of one functional surface to the adhesion surface of the cured application agent.

The attachment method described in this way does not need to be limited to applications within a building, but rather it is suitable for all applications in which a securing option has to be produced in combination with rough surfaces. For example, the fastening system according to the invention can also be used to attach a film-like functional part to the skin of a patient in a releasable manner. For example, spray application on the skin of the patient as a rough surface can take place with a commercially available spray plaster which has cured accordingly on the patient's skin, forming a smooth surface for attaching the microreplication surface of the film-like functional part, which can also be removed again in a releasable manner from the spray plaster. The film-like functional part can then, for example, be provided with at least one transponder in the context of so-called RFID technology, on which transponder specific patient data can be stored. Furthermore, the transponder technology of the functional part can make it possible to monitor individual patients who possibly have a tendency to become disoriented due to the type of disease they have. Overall, portable computer technologies can be implemented on the body by means of the fastening system as so-called wearables having different transmission technologies, such as Bluetooth, Wi-Fi, RFID, etc., and a variety of possible sensors, such as temperature measuring devices, conductivity detection of the skin, etc., which is advantageous in the context of health data acquisition.

### BRIEF DESCRIPTION OF THE DRAWINGS

The fastening system according to the invention is explained in more detail below with reference to exemplary embodiments according to the drawing. In the drawings, which are schematic representations that are not to scale:

FIGS. 1 to 4 show the application process for a fastening system according to the invention on a rough surface in the temporal sequence of the application;

FIG. 5 shows a greatly magnified representation of the film-like functional part used according to FIG. 4 having individual microstructures;

FIG. 6 shows a sales set designed in the manner of a film pouch having an application agent, functional part and a further hook-shaped functional component;

FIG. 7 shows a plan view of a fastening system attached to rough, painted masonry, with additionally attached fastening hooks on the rear side of a rectangular functional part; and

FIG. 8 shows a fastening system equipped with transponder technology and fitted on one side of a human wrist.

### DETAILED DESCRIPTION OF EMBODIMENTS OF THE INVENTION

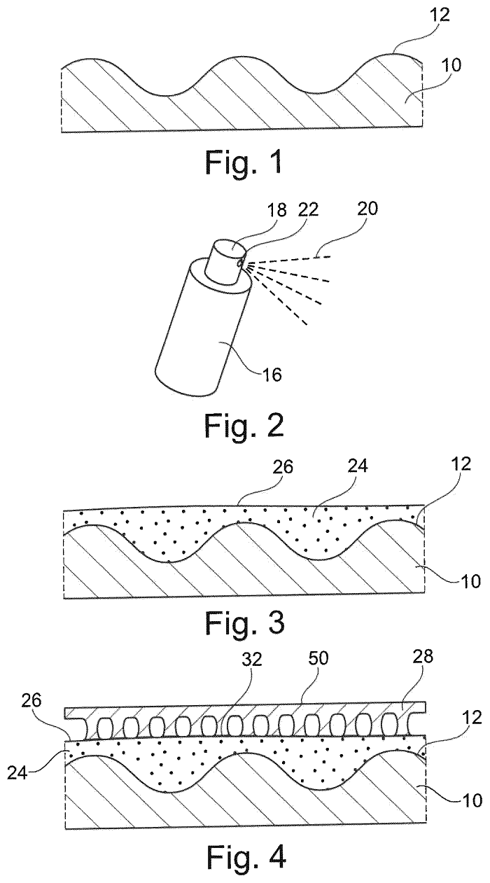

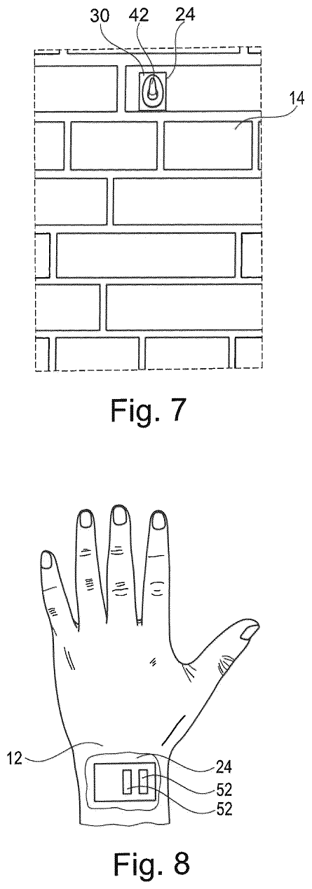

FIG. 1 is a schematically simplified and greatly magnified side view of an object 10 having a rough surface 12 on an exposed upper side of the object 10. By way of example, an object 10 of this kind can be in the form of painted clinker masonry 14, as shown in FIG. 7.

FIG. 2 shows a conventional spraying device 16 during spray operation, i.e., liquid spray discharge 20 takes place via a spray nozzle 22 in a spray button 18 when said spray button 18 is pressed multiple times by hand. In a preferred embodiment, the can-like spraying device 16 consists of an application device for spray plasters, but it is also readily possible to use a rubber spray for applying a sprayable, synthetic rubber mixture or a commercially available paint can for applying a vehicle paint, such as a car paint.

In principle, a polymer solution is suitable as a spray coating which, after evaporation of the solvent, forms a spray coating 24 on the rough surface 12 according to the representation according to FIG. 3, the spray coating 24, after curing, forming a smooth adhesion surface 26 on its outer side facing away from the rough surface 12. The polymer material used is, inter alia, polyvinyl pyrrolidone, nitrocellulose, ethyl cellulose or poly(methyl acrylate isobutene monoisopropyl maleate) (as a so-called static copolymer). However, one or more silicone-acrylate polymers and one or more silicone ethers having one or more carrier agents, selected from the group of the linear, cyclic or branched alkanes or alkenes which are gaseous or liquid at room temperature, have also proven to be particularly suitable in a preparation. This preparation for a spray coating 24 can be provided with flame-retardant additives and allows for good film formation with a smooth surface and rapid drying or curing of the applied spray coating film 24.

A spray coating 24 formed in this way, as well as an alternative spray coating consisting of polyurethane or rubber materials, can be removed from the object 10 or from the rough surface 12 thereof again after curing without leaving residue, if necessary; unlike in the case of (car) paints, which remain permanently adhered to the object 10. In particular, when the polymers mentioned are used, ethyl acetate or water is often used as the solvent. In this respect, the spray coating 24 is self-curing, it being possible to facilitate the curing, i.e., the crosslinking, by means of UV light, heat input and introduction of additional crosslinkers.

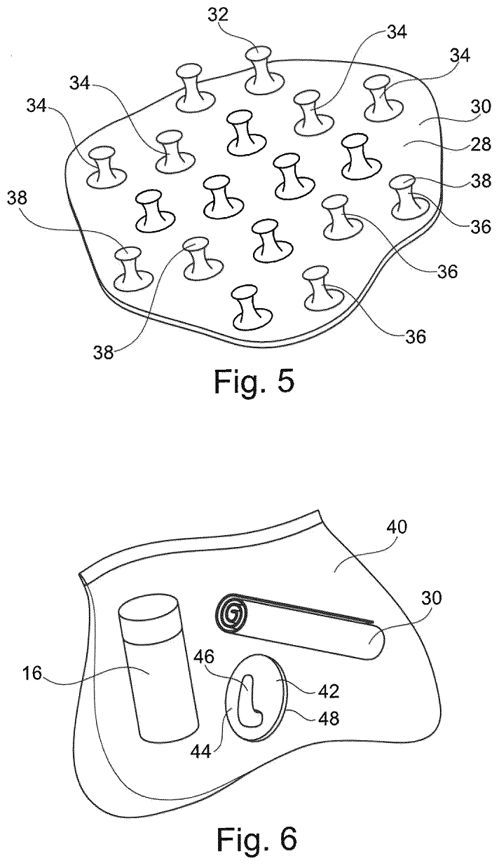

As can be seen, in particular, in FIG. 3, the spray coating 24 can also be realized over a large area and, in particular, there is also the possibility of providing the cured, smooth spray coating 26 with color, for example a wall paint, which should preferably also lead to a smooth adhesion surface 26 in the manner of a lacquer. If necessary, the application agent itself can also have a paint which allows for a large degree of design freedom for the user in adaptation to an otherwise used wall paint. In particular, in the case of a large-area application of the application agent, there is the possibility of providing a plurality of functional parts 28 having the cured application agent at one location. A functional part 28 of this kind is shown magnified in FIG. 5. In particular, the functional part 28 consists of a thin film 30 made of silicone material, preferably polyvinyl siloxane. In particular, the film 30 has a thickness of 0.15 to 5 mm and, on the upper side of the film as part of the functional surface 32, there are 15,000 to 55,000, particularly preferably 25,000 to 35,000 adhesive elements 34 per cm² of the film surface. The individual adhesive elements 34 are preferably all of the same design and an integral component of the film 30. Each adhesive element 34 has a stem part 36, which transitions on the base side into the surface of the film 30 and has a flat head part 38 on the head side, which head part is wider in diameter relative to the stem part 36. The planar head surfaces of each head part 38 form the upper end of the adhesive element 34 in a common plane parallel to the surface of the film 30 and the microstructures formed in this respect interact via the free head surface of each head part 38 by means of Van der Waals forces with the smooth adhesion surface 26 of the cured application agent applied in a planar manner on the surface 12 in the form of the spray coating 24.

Said functional part 28 according to FIG. 5 can be obtained during a so-called chill roll method, it also being possible to design the free head shapes differently, for example they could form a hexagonal cross section instead of a circle.

If the film 30 according to FIG. 5 is placed on the head and is brought into contact with the smooth adhesion surface 26, a fastening system as shown in FIG. 4 results, and this adherence takes place by means of adhesion between the free end faces of the adhesive elements 34 and the smooth surface or adhesion surface 26 of the spray coating 24. After overcoming this adhesive force, the functional part 28 can also be reversibly removed from the smooth adhesion surface 26 and, if necessary, the spray coating 24 can also be removed from the object 10 with its rough surface 12 as described without leaving residue. Furthermore, there is the possibility of allowing the spray coating 24 to remain in place and to be painted over if necessary.

As the representation according to FIG. 6 shows, a spraying device 16, for example, in the form of a spray can be accommodated in an openable film pouch 40 as a tradeable sales set together with a rolled-up film 30 according to the representation according to FIG. 5 and with an additional fastening means, in this case in the form of a commercially available wall hook 42 made of plastics material. The film-like functional part 28 often has a protective film on its microstructured surface as well as on its adhesive rear side, which makes rolling up more difficult, and therefore the functional part 28 can also be designed in the form of individual patches (not shown). On a fastening plate 44, the wall hook 42 has the actual projecting hook part 46 and the fastening plate 44 is provided at the rear with an adhesive coating 48 which is covered by a lamination film (not shown in greater detail). In this case, the functional part 28 has a back layer on its rear side facing the fastening plate 44, for example in the form of a fluorinated plastics film, preferably consisting of PES, PET, etc., such that the adhesive coating 48 of the fastening plate 44 remains adhered to the functional part 28, even if said functional part consists of silicone material, which is particularly adhesive-repellent. Instead of this solution, the functional part 28 can also be self-adhesive, for example provided with adhesives based on acrylate, rubber or silicone. The adhesive layer that is then uncovered by means of an additional cover film can then readily be firmly connected to the fastening plate 44.

FIG. 7 shows, by way of example, an application in which a sales set according to FIG. 6 can be used as shown.

First, the painted clinker masonry 14 is provided with a spray coating 24 from the spraying device 16 in the form of the spray can. After the spray coating 24 has cured on the rough surface 12, which often takes less than one minute for spray plaster application but can also take multiple hours in the case of rubber application, the unrolled film 30 can optionally be cut to size on site using scissors and placed on the smooth adhesion surface 26 according to the representation according to FIG. 4. The adhesive force already mentioned then holds the film 30 in contact with the cured spray coating 24 on the masonry 14. Subsequently, the lamination film is removed and the wall hook 42 is adhered by its rear-side adhesive coating 48 to the then exposed upper side 50 (FIG. 4) of the film 30, which is then provided with an additional film-like back layer. If the wall hook 42 is to be removed from the wall 14 again, it is removed, together with the film 30, from the spray coating 24, which has cured on the wall, by being pulled off, and the spray coating 24 is subsequently removed without leaving residue from the surface 12 of the object 10, in this case in the form of the clinker masonry 14. If a plurality of such wall hooks 42 are provided in the sales set according to FIG. 6, with a corresponding quantity of film material 30 as well as sufficient spraying agent in the spray can 6, the above-described hook structure can be implemented on a building wall 14 again. It should be emphasized again at this point that the attachment of the wall hook 42 is only an example and a variety of other possible applications of the fastening are conceivable in practice.

By way of example, reference is made in this context to a medical application according to FIG. 8. In this connection, a spray coating 24 in the form of a commercially available spray plaster can be applied on the outer side of the wrist of a patient. In this case, the skin of the patient is to be regarded as the rough surface 12. It is self-evident that, if necessary, the coating can additionally or alternatively also be applied on the inner side of the wrist. After the spray plaster has cured on the skin, the film 30 can in turn be applied, which in the present application scenario has at least one transponder chip 52 by means of which retrievable patient data can be stored or which allows the relevant location of the patient to be determined. In this respect, the RFID technology required for this is also fully available in the field of medicine, if necessary. In this case too, the film 30 can be removed again without problems and the breathable spray plaster coating can easily be washed off without leaving residue. The film 30 having the relevant transponder 52 can then be used again. Other solutions with wearables of this kind are possible.

A variety of further possible applications for the fastening system are conceivable here, which has no equivalent in the prior art. For example, according to the representation according to FIG. 4, further functional components (not shown) can be attached as an integral component or as a separate component on the upwardly exposed surface of the functional component 28, as disclosed by way of example in DE 10 2021 005 460 and DE 10 2020 006 092.

What is claimed is:

1. A fastening system, consisting at least of:
an application agent which, when viewed in relation to a surface to which it is applied, forms a smooth adhesion surface; and
a functional part which, on its side facing the adhesion surface, has a functional surface which can be secured to the adhesion surface in a releasable manner.

2. The fastening system according to claim 1, wherein the application agent is in the form of an adhesive strip.

3. The fastening system according to claim 1, wherein the application agent can be removed from the surface again without leaving residue or can be painted over.

4. The fastening system according to claim 1, wherein the functional surface of the functional part is microstructured, and in that the microstructures interact substantially by means of Van der Waals forces with the adhesion surface of the cured application agent applied in a planar manner on the surface.

5. The fastening system according to claim 1, wherein the functional surface of the functional part consists of 15,000 to 55,000 adhesive elements per cm² of the film surface.

6. The fastening system according to claim 1, wherein the functional surface of the functional part consists of 25,000 to 35,000 adhesive elements per cm² of the film surface.

7. The fastening system according to claim 1, wherein the film-like functional part consists of a silicone material.

8. The fastening system according to claim 1, wherein the functional part is in the form of a film and, on its one film side, has the functional surface having the microstructures and, on its opposite additional film side, has a securing option for further components.

9. A fastening system, consisting at least of:
an application agent which, when viewed in relation to a surface to which it is applied, forms a smooth adhesion surface; and
a functional part which, on its side facing the adhesion surface, has a functional surface which can be secured to the adhesion surface in a releasable manner;
wherein the application agent is in the form of an adhesive strip;
wherein the application agent can be removed from the surface again without leaving residue or can be painted over; and
wherein the functional surface of the functional part is microstructured, and in that the microstructures interact substantially by means of Van der Waals forces with the adhesion surface of the cured application agent applied in a planar manner on the surface.

10. A fastening system, consisting at least of:
an application agent which, when viewed in relation to a surface to which it is applied, forms a smooth adhesion surface; and
a functional part which, on its side facing the adhesion surface, has a functional surface which can be secured to the adhesion surface in a releasable manner;
wherein the application agent is in the form of an adhesive strip;
wherein the application agent can be removed from the surface again without leaving residue or can be painted over; and
wherein the functional surface of the functional part is microstructured, and in that the microstructures interact substantially by means of Van der Waals forces with the adhesion surface of the cured application agent applied in a planar manner on the surface;
wherein the functional surface of the functional part consists of 15,000 to 55,000 adhesive elements per cm² of the film surface; and
wherein the functional part is in the form of a film and, on its one film side, has the functional surface having the microstructures and, on its opposite additional film side, has a securing option for further components.
